(19) United States
(12) Patent Application Publication
(10) Pub. No.: US 2021/0285527 A1
(43) Pub. Date: Sep. 16, 2021

(54) Assembly for converting motion

(71) Applicant: Ten Fold Engineering Limited, Buckinghamshire (GB)

(72) Inventor: David Martyn, Wallingford (GB)

(73) Assignee: Ten Fold Engineering Limited, Buckinghamshire (GB)

(21) Appl. No.: 17/331,496

(22) Filed: May 26, 2021

Related U.S. Application Data
(62) Division of application No. 16/443,636, filed on Jun. 17, 2019.

(30) Foreign Application Priority Data
Jun. 18, 2018 (GB) 1809971.3

(51) Int. Cl. F16H 21/44

(52) U.S. Cl. CPC F16H 21/44

(57) ABSTRACT

An assembly for converting motion has a first member; a second member pivotally connected at a first position to a first position on the first member; a third member pivotally connected at a first position to a second position on the first member; and a fourth member pivotally connected at a first position to a second position on the second member and pivotally connected at a second position to a second position on the third member; wherein the distance between the first position on the second member and the second position on the second member is a distance X and the distance between the first position on the fourth member and the second position on the fourth member is a distance Y; wherein X is equal to Y.

### CROSS-REFERENCE TO RELATED APPLICATIONS

This application is a U.S. divisional patent application of Ser. No. 16/443,636, filed on Jun. 17, 2019, which claims priority to GB application No. 1809971.3 filed Jun. 18, 2018.

### BACKGROUND OF THE INVENTION

The present invention relates to an assembly for converting motion. The assembly may be used to produce a straight line motion, in particular for producing motion of a component in a straight line generated by the rotational movement of a second component or the motion of the second component about a pivot.

Mechanisms for converting motion, in particular producing a straight line motion from a rotational motion are known in the art. Such straight line mechanisms may be characterised by comprising a first member rotatable about an axis passing through the member and a second member linked to or associated with the first member, the arrangement being such that rotational movement of the first member about the axis results in a straight line movement of the second member.

Examples of early mechanisms for producing a straight line motion include the straight line mechanism design by James Watt, comprising a series of three levers in end-to-end configuration, with movement of the two end levers about pivots at their free ends causing the middle lever to follow a close approximation to a straight line over a portion of its movement. A related linkage comprising three levers, with the middle lever constrained to follow a straight line was proposed by Tchebicheff. The Peaucellier-Lipkin inversor consists of an arrangement of seven levers and provides a conversion of circular motion into linear motion and vice versa. A related four-lever mechanism was proposed by Hart. A linear converter, known as the half beam mechanism, in which a first linear motion is converted to a second linear motion perpendicular to the first, was designed by Scott Russell.

An analysis of a variety of multi-lever, straight line linkages is provided by Dijksman, E. A. ‘Advances in Robot Kinematics and Computationed Geometry’, pages 411 to 420, [1994] Kluwer Academic Publishers.

U.S. Pat. No. 4,248,103 discloses a straight line mechanism, in particular a mechanism of the so-called ‘conchoid’ type. There is disclosed a linkage mechanism for an industrial manipulator comprising at least two of the said straight line mechanisms.

U.S. Pat. No. 4,400,985 concerns a straight line link mechanism, comprising a plurality of pivotally connected links. The links are connected between a support and a controlled member. As one of the links is moved in a 360° arc, the controlled member alternately moves in a first direction along a linear path and thereafter in the opposite direction along a curved path. The weight of the controlled member may be balanced by the use of a counter weight, to provide a lifting mechanism. A cam may be employed to control the motion of the controlled member.

More recently, U.S. Pat. No. 4,747,353 discloses a straight line motion mechanism formed from a pair linkage mechanisms arranged in a parallelogram in combination with a motion control means. The motion control means interconnects the two linkage mechanisms and provide a uniform angular displacement of each linkage mechanism.

U.S. Pat. No. 5,102,290 concerns a transfer device for transferring a workpiece from a first location to a second location. The workpiece is moved in a trochoidal arc by means of a pickup arm mounted to roll along a flat surface.

A straight line mechanism is disclosed in U.S. Pat. No. 5,237,887. The mechanism comprises a static base and a platform supported by first and second arm assemblies. Each of the first and second arm assemblies comprises portions pivotally connected to the static base. The arrangement of the pivoted arm portions of each arm assembly is such that the platform is constrained to move in a straight line, as the portions of the arms move about their respective pivot connections.

Still more recently, WO 97/33725 discloses a device for the relative movement of two elements. The device comprises at least two first links connected to a first element by a hinged connection so as to form a four-hinge system and pivot in a plane parallel to the plane of the first element. At least two second links are connected to the second element so as to form a four-hinge system and to pivot in a plane parallel to the plane of the second element. The two four-hinge systems provided by the first and second links are coupled in series to allow relative motion of the first and second elements.

WO 99/14018 discloses a device for the relative movement of two elements. The device comprises at least two link devices coupled between the elements, each comprising two mutually articulated link units. A first link unit is connected to first, moveable element. The second of the link units is connected to the second, static element. Power applied to the link units causes the first element to move relative to the second.

A mechanical linkage is described and shown in U.S. Pat. No. 2,506,151. The linkage comprises a plurality of interconnected levers. The linkage provides for movement of one member with respect to a fixed member. The linkage is specifically described and shown for use in providing movement for components of a chair, in particular to allow for movement of the seat of the chair in a rearwardly-downwardly and forwardly-upwardly direction. The linkage is indicated in U.S. Pat. No. 2,506,151 to provide for movement of the moveable member in a straight path with respect to the fixed member.

U.S. Pat. No. 2,529,451 discloses a linkage for a chair for a theatre. The linkage connects the seat portion of the seat to the back portion, allowing relative movement between the seat and the back.

Perhaps most recently, WO 2013/182834 discloses an assembly for converting motion. The assembly comprises:

a first arm rotatable at a first position thereon about a first fixed pivot;

a second arm rotatable at a first position thereon about a second fixed pivot, the second fixed pivot spaced apart from the first fixed pivot;

a third arm pivotably connected at a first position thereon to the second arm at a second position on the second arm, the second position spaced apart from the first position on the second arm;

a first connecting arm extending between the first arm and the third arm, the first connecting arm pivotably connected to a second position on the first arm spaced apart from the first position and pivotably connected to the third arm at a second position thereon spaced apart from the first position thereon; and

a second connecting arm extending between the first arm and the second arm, the second connecting arm pivotably connected to a third position on the first arm disposed between the first and second positions thereon and pivotably connected to a third position on the second arm.

Developments of the assembly of WO 2013/182834 are disclosed in subsequently published documents, including WO 2014/029954, WO 2014/184513, WO 2015/033111, WO 2015/033116, WO 2016/030659, and WO 2016/030660.

There is a continuing need for an improved assembly for providing a straight line motion, in particular for providing an element moveable in a straight line in response to a rotational motion. It would be most advantageous if the assembly could be arranged in a compact form, thereby occupying only a small volume of space.

An assembly for converting motion has now been found. The assembly may be used to convert a rotary motion into a range of movements. In particular, the assembly may be used to form part of an assembly to convert a rotary motion into a straight line motion has now been found which relies upon an assembly of members, such as levers or arms having pivoted connections therebetween. The basic assembly represents a compact arrangement, which can be assembled using a minimum number of different components, but which exhibits great versatility in constructing a wide range of different assemblies. The basis assembly can be employed on a modular basis, with a plurality of similar assemblies interconnected to provide a range of structures and movements.

### BRIEF SUMMARY OF THE INVENTION

According to the present invention there is provided an assembly for converting motion, the assembly comprising:

a first member;

a second member pivotally connected at a first position on the second member to a first position on the first member;

a third member pivotally connected at a first position on the third member to a second position on the first member, the second position on the first member being spaced apart from the first position on the first member; and

a fourth member pivotally connected at a first position on the fourth member to a second position on the second member and pivotally connected at a second position on the fourth member to a second position on the third member, the second position on the second member being spaced apart from the first position on the second member and the second position on the third member being spaced apart from the first position on the third member;

wherein the distance between the first position on the second member and the second position on the second member is a distance X and the distance between the first position on the fourth member and the second position on the fourth member is a distance Y; and

wherein the distance X is equal to the distance Y.

It has been found that the arrangement defined above provides a particularly advantageous assembly that may be employed in a wide range of structures and linkages. Such structures and linkages can be employed for a wide range of applications, such as moving components and/or supporting components.

In particular, it has been found that the assembly as defined above can provide the basis for an assembly that performs as a straight line converter, with the advantage that the assembly can be formed from a minimum number of different components. In this respect, it is to be understood that the term ‘straight line converter’ is a reference to assemblies, structures or linkages that convert a rotary motion of one component into a straight line movement of at least a portion of another component of the assembly, including substantially straight line movement wherein the movement deviates from a precise straight line by a very minor amount.

Further, the assembly of the present invention can be used as a module in an assembly comprising a plurality of modules, which can be employed to provide a wide range of motion from an applied rotational force.

In the assembly of the present invention, the members rotate about the pivot connections between the members, under the action of a force applied to a member of the assembly. With respect to the movement of the members of the assembly, the assembly can be considered to have a retracted position, in which the members of the assembly lie adjacent one another, and an extended position, in which the members of the assembly have been moved out of the retracted position. The assembly may be configured to have a single extended position, for example an extended position in which one or more members are locked, as described in more detail below, or a plurality of extended positions.

For example, the first member may be considered as being a fixed member, with the second, third and fourth members of the assembly moving relative to the first member. A rotational force may be applied to the second member or the third member, which causes the second and third members to rotate about their respective pivot connections with the first member. At the same time, the fourth member moves about its pivot connections with each of the second and third members.

In a similar manner, one of the second, third or fourth members may be considered as a fixed member, with the other of the second, third and fourth members, together with the first member moving relative to the fixed member.

The assembly has been defined hereinbefore by reference to a plurality of members. It is to be understood that the term ‘members’ is used as a general reference to any component that may be connected as hereinbefore described and/or moved about a pivot connection to another member. Accordingly, the term ‘member’ is to be understood as being a reference to any such component, regardless of shape or configuration, and includes arms, levers and the like.

As described in more detail below, members of the assembly of the present invention are pivotably connected to one another. The reference herein to a ‘pivot connection’ or the like is a reference to a connection that is a revolute and can be provided by any form of connection that allows one member to rotate about its connection with another member. Suitable forms of connection that provide the required pivotal movement of interconnected members include hinge joints, spherical joints and ball joints. In one preferred embodiment, the pivot connections between members is formed by a pin, spindle or axle about which one or both of the interconnected members is able to rotate.

The assembly may employ a single type of pivot connection for all the pivot connections between the members. This has an advantage of ease of manufacture and assembly. Alternatively, the assembly may comprise pivot connections between the members formed from two or more different types of pivot connection.

The assembly of the present invention comprises a first member. The first member may have any shape and configuration. In many embodiments, the first member will be provided by a fixed structure, such as a frame or fixed component, with the second, third and fourth members of the assembly moving relative to the first member. In other embodiments, the first member is a component of a larger assembly of which the assembly of the present invention comprises a part. In such embodiments, a preferred form for the first member is an elongate member, for example an arm, bar or a rod.

The assembly further comprises a second member. The second member may have any shape and configuration. A preferred form for the second member is an elongate member, for example an arm, a bar or a rod.

The second member is pivotably connected at a first position on the second member to the first member at a first position on the first member.

The first position on the first member may be at any suitable location on the first member. In embodiments in which the first member is provided by a fixed component or a fixed structure, such as a building or a component of a fixed frame or the like, the first position on the first member is provided at an appropriate position on the fixed component or structure. In embodiments in which the first member is an elongate member, the first position may be at or adjacent one end of the first member. In other embodiments, the first position on the first member is between the ends of the first member.

The first position on the second member may be in any suitable location on the second member. In many preferred embodiment, the first position is at or adjacent one end of the second member. In other embodiments, the second member extends beyond the first position on the second member, such that the first position lies between the ends of the second member.

The second member may rotate about the pivot connection with the first member under the action of movement of another member of the assembly or by an external force, such as a rotational force or a translational force, applied to the second member. The second member may function as a driving member for the assembly, that is have a force applied thereto so as to rotate the second member about the pivot connection at the first position on the first member, thereby transferring drive to the other components of the assembly. Alternatively, the second member may be a driven member of the assembly, that is rotate about the pivot connection with the first member under the action of the other components of the assembly.

The assembly further comprises a third member. The third member may have any shape and configuration. A preferred form for the third member is an elongate member, for example an arm, a bar or a rod.

The third member is pivotably connected at a first position on the third member to a second position on the first member.

The second position on the first member is spaced apart from the first position on the first member and may be at any suitable location on the first member. In embodiments in which the first member is provided by a fixed component or a fixed structure, such as a building or a component of a fixed frame or the like, the second position on the first member is provided at an appropriate position on the fixed component or structure, spaced apart from the first position on the first member. In embodiments in which the first member is an elongate member, the second position may be at or adjacent one end of the first member. In other embodiments, the second position on the first member is between the ends of the first member.

The first position on the third member may be in any suitable location on the third member. In one preferred embodiment, the first position is at or adjacent one end of the third member. In other embodiments, the third member extends beyond the first position on the third member, such that the first position lies between the ends of the third member.

The third member may rotate about the pivot connection with the first member under the action of movement of another member of the assembly or by an external force, such as a rotational force or a translational force, applied to the third member. The third member may function as a driving member for the assembly, that is have a force applied thereto so as to rotate the third member about the pivot connection at the first position on the first member, thereby transferring drive to the other components of the assembly. Alternatively, the third member may be a driven member of the assembly, that is rotate about the pivot connection with the first member under the action of the other components of the assembly.

The assembly further comprises a fourth member. The fourth member extends between and interconnects the second member and the third member.

The fourth member may have any shape and configuration. A preferred form for the fourth member is an elongate member, for example an arm, a bar or a rod.

The fourth member is pivotably connected to each of the second and third members, as follows:

The fourth member is pivotably connected at a first position on the fourth member to a second position on the second member.

The second position on the second member is spaced apart from the first position on the second member by a distance X. Further details regarding the distance X are discussed below. The second position on the second member may be at or adjacent an end of the second member. More preferably, the second position on the second member is located between first and second ends of the second member, as described in more detail below.

The first position on the fourth member may be at any suitable position on the fourth member. In one preferred embodiment, the first position on the fourth member is at or adjacent an end of the fourth member. In another preferred embodiment, the first position on the fourth member lies between first and second ends of the fourth member, as described in more detail below.

The fourth member is pivotably connected at a second position on the fourth member to a second position on the third member.

The second position on the third member is spaced apart from the first position on the third member. The second position on the third member may be at any suitable position on the third member. In one preferred embodiment, the second position on the third member is at or adjacent an end of the third member. In another embodiment, the second position on the third member lies between first and second ends of the third member.

The second position on the fourth member is spaced from the first position on the fourth member by a distance Y. Details of the distance Y are discussed below. In one preferred embodiment, the second position on the fourth member is at or adjacent an end of the fourth member. In another preferred embodiment, the second position on the fourth member lies between first and second ends of the fourth member.

As noted above, the first member may be provided by a fixed structure, such as a building or frame. In this case, the first and second positions on the first member are appropriately spaced apart positions on the fixed structure. Alternatively, for many embodiments, the first member is a rod, bar or lever of a similar form to the other members of the assembly. In many such embodiments, it is preferred to have the first and/or second positions on the first member at or adjacent one or respective ends of the first member. Preferably, the first member is formed to have the first position at or adjacent a first end of the first member and the second position at or adjacent a second end, such that the length of the first member is substantially the distance between the first and second positions on the first member.

As noted above, the second member is pivotally connected to the first member at the first position on the second member. In one preferred embodiment, the first position on the second member is at a first end of the second member. Alternatively, the second member may extend from the second position on the second member in the direction of the first position on the second member beyond the first position on the second member. In this way, in an extended position of the assembly, the second member extends from the second position on the second member in the direction of the first position on the second member beyond the first position on the second member and to or beyond the first member.

The second member may have the second position on the second member at or adjacent an end of the second member, as noted above. However, it is preferred to have the second member extend from the first position on the second member in the direction of the second position of the second member beyond the second position on the second member. In this embodiment, the length of the second member from its first end to its second end may be equal to the distance between the first and second positions on the first member. In this way, the first and second members can be formed as very similar components with the same or similar lengths, which eases manufacture of the components of the assembly.

In a preferred embodiment, the second member is of a length such that, in an extended position, the second member extends from the first position on the second member to the second position on the second member and to the third member. In this way, the second member and the third member may be arranged to lock together in the extended position. In this embodiment, an end of the second member may lie at or adjacent the third member in the extended position. In many preferred embodiments, the second member extends beyond the third member in the extended position.

As noted above, the fourth member is pivotally connected to the second member at a first position on the fourth member. The fourth member may have the first position on the fourth member at or adjacent an end of the second member, as noted above. This is very suitable for many embodiments and in many embodiments is preferred. However, it is preferred for some embodiments to have the fourth member extend from the second position on the fourth member in the direction of the first position of the fourth member beyond the first position on the fourth member. In this embodiment, the length of the fourth member from its first end to its second end may be equal to the distance between the first and second positions on the first member. In this way, the first and fourth members can be formed as very similar components with the same or similar lengths, which eases manufacture of the components of the assembly.

In a preferred embodiment, the fourth member is of a length such that, in an extended position, the fourth member extends from the second position on the fourth member to the first position on the fourth member and to the first member. In this way, the fourth member and the first member may be arranged to lock together in the extended position. In this embodiment, an end of the fourth member may lie at or adjacent the first member in the extended position. In many preferred embodiments, the fourth member extends beyond the first member in the extended position.

In one preferred embodiment, the second position on the fourth member is at an end of the fourth member. Alternatively, the fourth member may extend from the first position on the fourth member in the direction of the second position on the fourth member beyond the second position on the fourth member and beyond the third member. In this way, in an extended position of the assembly, the fourth member extends from the first position on the fourth member in the direction of the second position on the fourth member beyond the second position on the fourth member and beyond the third member.

As noted above, the third member is pivotally connected to the first member at the first position on the third member. In one preferred embodiment, the first position on the third member is at a first end of the third member. Alternatively, the third member may extend from the second position on the third member in the direction of the first position on the third member beyond the first position on the third member. In this way, in an extended position of the assembly, the third member extends from the second position on the third member in the direction of the first position on the third member beyond the first position on the third member and beyond the first member.

The third member may have the second position on the third member at or adjacent an end of the third member, as noted above. However, it is also preferred to have the third member extend from the first position on the third member in the direction of the second position of the third member beyond the second position on the third member and beyond the fourth member.

The first, second, third and fourth members may have any suitable length.

In one preferred embodiment, the first member is equal in length to the second member. In another preferred embodiment, the first member is equal in length to the third member. In a further preferred embodiment, the first member is equal in length to the fourth member.

In one preferred embodiment, the second member is equal in length to the third member. In another preferred embodiment, the second member is equal in length to the fourth member.

In one preferred embodiment, the third member is equal in length to the fourth member.

It is an advantage of the assembly of the present invention that the first, second, third and fourth members may all be provided to have the same length. This eases manufacture and assembly of structures in which the assembly is comprised.

The assembly of the present invention can be employed to convert motion. As discussed above, the assembly of the present invention may be used as the basis for an assembly that converts rotational movement into a movement along a substantially straight line. In particular, applying a rotational force to one of the members, for example the second member or the third member, causes members of the assembly to move in a pattern that defines a point that moves in a substantially straight line. Depending upon the configuration of the assembly, the converted movement can be a very close approximation to a straight, as discussed in more detail below.

In preferred embodiments, the assembly of the present invention comprises one or more further members pivotably connected to one or more of the aforementioned first, second, third and/or fourth members. In this way, the assembly may be used to provide a wide range of patterns of movement resulting from a force applied to one of the first, second, third or fourth members. In particular, the assembly may be provided with one or more further members having thereon the point moving in a substantially straight line as the assembly moves between the extended and retracted positions.

In one preferred embodiment, the assembly comprises a fifth member and a sixth member, to provide an assembly of a similar general configuration to that described and shown in WO 2013/182834.

More particularly, one embodiment of the assembly comprises:

a first member;

a second member pivotally connected at a first position on the second member to a first position on the first member;

a third member pivotally connected at a first position on the third member to a second position on the first member, the second position on the first member being spaced apart from the first position on the first member;

a fourth member pivotally connected at a first position on the fourth member to a second position on the second member and pivotally connected at a second position on the fourth member to a second position on the third member, the second position on the second member being spaced apart from the first position on the second member and the second position on the third member being spaced apart from the first position on the third member;

a fifth member pivotally connected at a first position on the fifth member to the second position on the third member and the second position on the fourth member; and

a sixth member pivotally connected at a first position on the sixth member to a third position on the second member, wherein the third position on the second member is spaced from the second position on the second member in the direction extending from the first position on the second member to the second position on the second member, and a second position on the fifth member, the second position on the fifth member being spaced apart from the first position on the fifth member;

wherein the distance between the first position on the second member and the second position on the second member is a distance X and the distance between the first position on the fourth member and the second position on the fourth member is a distance Y; and

wherein the distance X is equal to the distance Y.

In the assembly of this embodiment, the fifth member can be of a sufficient length that a point P on the fifth member spaced from the first and second positions on the fifth member and beyond the second position in the direction from the first to the second position can be identified as moving in a substantially straight line as the assembly moves between the retracted position and an extended position. Preferably, the point on the fifth member moves in a substantially straight line that extends perpendicular to the line joining the first and second positions on the first member.

In addition, by allowing the assembly to further extend, the aforementioned point on the fifth member can be caused to move in an arc from the end of the substantially straight line path.

The fifth member may be of any suitable length that includes the first position, the second position and the aforementioned point on the fifth member. In one embodiment, the first position on the fifth member is at or adjacent a first end portion of the fifth member, preferably at the end of the fifth member. In one embodiment, the aforementioned point on the fifth member is at or adjacent a second end portion of the fifth member, preferably at a second end of the fifth member.

In one preferred embodiment, the distance between the first position on the fifth member and the aforementioned point on the fifth member is equal to the length of one or more of the first, second or third members. In this way, the assembly may be formed from a minimum number of identical or similar components, thereby easing manufacture of the components.

The sixth member may have any suitable length. In one embodiment, the first position on the sixth member is at or adjacent a first end portion of the sixth member, preferably at the end of the sixth member. In one embodiment, the second position on the sixth member is at or adjacent a second end portion of the sixth member, preferably at a second end of the sixth member. In an alternative embodiment, the sixth member extends from the first position on the sixth member to the second position on the sixth member and beyond the fifth member. In one embodiment, the length of the sixth member is equal to the length of one or more of the first, second, third, fourth and fifth members. Again, this eases manufacture of the components of the assembly.

In one preferred embodiment, the distance between the first and second positions on the sixth member is the same as the distance between the first and second positions on the fourth member, that is the distance Y.

In another preferred embodiment, the assembly further comprises a seventh member and an eighth member, to provide an assembly of a similar general configuration to that described and shown in WO 2015/033111.

More particularly, one embodiment of the assembly comprises:

a first member;

a second member pivotally connected at a first position on the second member to a first position on the first member;

a third member pivotally connected at a first position on the third member to a second position on the first member, the second position on the first member being spaced apart from the first position on the first member;

a fourth member pivotally connected at a first position on the fourth member to a second position on the second member and pivotally connected at a second position on the fourth member to a second position on the third member, the second position on the second member being spaced apart from the first position on the second member and the second position on the third member being spaced apart from the first position on the third member;

a fifth member pivotally connected at a first position on the fifth member to the second position on the third member and the second position on the fourth member;

a sixth member pivotally connected at a first position on the sixth member to a third position on the second member, wherein the third position on the second member is spaced from the second position on the second member in the direction extending from the first position on the second member to the second position on the second member, and a second position on the fifth member, the second position on the fifth member being spaced apart from the first position on the fifth member;

wherein the fifth member is of a sufficient length that a point P on the fifth member spaced from the first and second positions on the fifth member and beyond the second position in the direction from the first to the second position on the fifth member moves in a substantially straight line as the assembly moves between the retracted position and an extended position;

the assembly further comprising:

a seventh member pivotally connected at a first position on the seventh member to the point P on the fifth member; and

an eighth member pivotally connected at a first position on the eighth member to the third position on the second member and pivotally connected at a second position on the eighth member to a second position on the seventh member, the second position on the seventh member being spaced apart from the first position on the seventh member;

wherein the distance between the first position on the second member and the second position on the second member is a distance X and the distance between the first position on the fourth member and the second position on the fourth member is a distance Y; and

wherein the distance X is equal to the distance Y.

In the assembly of this embodiment, the seventh member is pivotally connected to the point P on the fifth member, as hereinbefore described. As a result, the seventh member moves in a substantially straight line as the assembly moves between the retracted position and an extended position.

The seventh member may be of any suitable length that includes the first position and the second position thereon. In one preferred embodiment, the distance between the first and second positions on the seventh member is equal to the distance between the first and second positions on the first member.

In one embodiment, the first position on the seventh member is at or adjacent a first end portion of the seventh member, preferably at the end of the fifth member. In one embodiment, the second position on the seventh member is at or adjacent a second end portion of the seventh member, preferably at a second end of the seventh member.

In one preferred embodiment, the length of the seventh member is equal to the length of the first member. In this way, the assembly may be formed from a minimum number of identical or similar components, thereby easing manufacture of the components.

The eighth member may have any suitable length. In one embodiment, the first position on the eighth member is at or adjacent a first end portion of the eighth member, preferably at the end of the eighth member. In one embodiment, the second position on the eighth member is at or adjacent a second end portion of the eighth member, preferably at a second end of the eighth member. In an alternative embodiment, the eighth member extends from the first position on the eighth member to the second position on the eighth member and beyond the seventh member.

In one embodiment, the length of the eighth member is equal to the length of one or more of the first, second, third, fourth, fifth, sixth and seventh members. Again, this eases manufacture of the components of the assembly.

In one preferred embodiment, the distance between the first and second positions on the eighth member is the same as the distance between the first and second positions on the third member.

As discussed above, the distance between the first and second positions on the second member is designated herein as distance X. The distance between the first and second positions on the fourth member is designated herein as distance Y. In the assembly of the present invention, the distances X and Y are equal.

It has now been found that the lengths of the distances X and Y may be selected to have a significant effect on the behaviour of the assembly. In particular, taking the distance between the first and second positions on the first member as being A, then X and Y preferably both have a length represented by the following formula:

A/(1+ϕ) (I)

where ϕ is as follows:

1<ϕ≤2.

It has been found that when X and Y are equal and have the value determined using formula (I) above then the assembly of the present invention can provide the basis for a straight line converter, that is convert a rotational movement into a substantially linear movement.

ϕ may have any value that is greater than 1 and less than or equal to 2. The value of ϕ determines a number of the dimensions and features of the assembly, including the angle between the first and third members when the assembly is in an extended position corresponding to the end of the substantially straight line path, herein referred to as the angle α. In particular, the aforementioned angle is given by the formula (II):

α=arccos(ϕ/2) (II).

ϕ may have a value up to and including 2. ϕ is preferably less than 2.

Preferably, ϕ is from 1.1 to ≤2, more preferably from 1.2 to ≤2.

ϕ preferably has a value up to 1.95, more preferably up to 1.9, still more preferably up to 1.85, more preferably still up to 1.8, especially up to 1.75.

In preferred embodiments, ϕ has a value to give an angle α of from 5°, preferably from 10°, more preferably from 15°, still more preferably from 20°, more preferably still from 25°. ϕ is preferably selected to given an angle α of up to 59°, more preferably up to 57°, still more preferably up to 55°.

In one preferred embodiment, ϕ has the value of 1.285, giving a value of α of 50°.

In another preferred embodiment, ϕ has the value of the square root (herein SQRT) of 2, that is SQRT(2), that is 1.414, giving a value of α of 45°.

In an alternative preferred embodiment, ϕ has the value 1.532, giving a value of α of 40°.

In a further preferred embodiment, ϕ has the value [(SQRT(5)+1)/2], that is 1.618, giving a value of α of 36°.

In another preferred embodiment, ϕ has the value SQRT(3), that is 1.732 giving a value of a of 30°.

It has been found that as the value of ϕ moves from 1 to 2, the nature of the straight line movement varies. As ϕ approaches 1, the movement in a straight line that may be achieved using the assembly increases to a maximum. However, the deviation of the movement from a straight line increases. Conversely, as ϕ moves from 1 to 2, the movement in a straight line that may be achieved using the assembly reduces and becomes a minimum when ϕ=2. However, the deviation of the movement from a straight line reduces. As a consequence, the procedure to be followed when designing an assembly of the present invention preferably takes into account the required length of straight line movement required of the assembly and the deviation of the straight line movement from a precise straight line.

Accordingly, in a further aspect, the present invention provides a method for providing an assembly for converting motion, the method comprising:

providing a first member;

providing a second member pivotally connected at a first position on the second member to a first position on the first member;

providing a third member pivotally connected at a first position on the third member to a second position on the first member, the second position on the first member being spaced apart from the first position on the first member; and

providing a fourth member pivotally connected at a first position on the fourth member to a second position on the second member and pivotally connected at a second position on the fourth member to a second position on the third member, the second position on the second member being spaced apart from the first position on the second member and the second position on the third member being spaced apart from the first position on the third member;

wherein the distance between the first position on the second member and the second position on the second member is a distance X and the distance between the first position on the fourth member and the second position on the fourth member is a distance Y; and

wherein the distance X is equal to the distance Y;

the method further comprising:

determining the extent of straight line motion required to be generated by the assembly and the deviation of this motion from a straight line;

and

selecting the value of X and Y to provide the predetermined motion.

As discussed above, the appropriate value of X and Y is preferably determined by selecting a value for ϕ. As will be shown below in the specific examples, the selection of the value of ϕ, and hence the value of X and Y, determines the characteristics of the assembly and any structure comprising the structure, in particular the shape of the structure when in an expanded position.

The embodiments of the assembly of the present invention described above, in particular the embodiment comprising fifth and sixth members and the embodiment further comprising seventh and eighth members, can be formed by an analogous method.

The assembly of the present invention finds wide applications and uses, in particular by allowing relative movement between a first component and a second component.

It is a further advantage of the assembly of present invention that it is highly scalable and may be constructed and applied at a wide range of scales to convert motion, as described hereinbefore.

Accordingly, in a further aspect, the present invention provides an assembly comprising a first component and a second component, the first component being arranged for movement with respect to the second component, wherein an assembly as hereinbefore described is provided between the first component and second component, operation of the assembly providing movement of the first component with respect to the second component.

One of the first and second components is preferably connected to or forms one of the members of the assembly. In many embodiments, one of the first or second components is connected to or forms the first member. The other of the first and second components is connected directly, or indirectly by one or more further members, to another member of the assembly. In this way, movement of the first component with respect to the second component is effected.

The assembly comprising the first and second components finds extensive use in providing relative movement between two components. For example, the assembly finds use in moving a first component in a substantially linear motion between a retracted position and an extended position relative to the second component. Further, the assembly finds use in displacing and rotating a first component relative to a second component.

In many applications, a plurality of assemblies of the present invention is employed. In particular, a plurality of assemblies may be employed in a spaced apart relationship on opposing sides of an object to be moved. For example, a first and second assembly may be provided on opposing sides of an object to be moved.

Applications of the assembly of the present invention to convert motion, for example to convert rotational motion to a substantially linear motion, include the support and movement of building structures relative to one another.

Accordingly, the present invention further provides a building comprising:

a first building portion and a second building portion, the first building portion being moveable relative to the second building portion between a retracted position and an extended position;

wherein relative movement between the first and the second building portions and support of one of the first and second building portions with respect to the other of the first and second building portions are provided by an assembly as hereinbefore described.

The first building portion may be any structure or part of a building, in particular a fixed structure, such as a house, apartment or office building, or a mobile building structure, such as a mobile house, caravan or the like. The second building structure may be any structure or component of the installation that is required to be moved relative to the first building portion between the retracted and extended positions. Examples of such structures include walls, floors, balconies, floor extensions, roofs, roof extensions, canopies and the like.

As discussed above, the assembly of the first aspect of the present invention is modular and a plurality of such assemblies can be combined to provide a structure moveable between a retracted position and an extended position.

Accordingly, in a further aspect, the present invention provides a structure moveable between a retracted position and an extended position, the structure comprising a plurality of assemblies as hereinbefore described.

In one embodiment, the structure comprises a plurality of assemblies directly connected to one another, that is one or more members of a first assembly are directly connected to a member of a second assembly. In alternative embodiments, one or more members of a first assembly are indirectly connected to a member of a second assembly by way of one or more additional members.

### BRIEF DESCRIPTION OF THE SEVERAL VIEWS OF THE DRAWINGS

The principles and operation of the assembly of the present invention and embodiments employing the assembly will be further explained by reference to the accompanying figures, in which:

FIG. 1 is a diagrammatic representation of an assembly according to one embodiment of the present invention;

FIG. 2 is a diagrammatic representation of an assembly according to a second embodiment of the present invention;

FIG. 3 is a diagrammatic representation of an assembly according to a third embodiment of the present invention;

FIG. 4 is a diagrammatic representation of an assembly according to a fourth embodiment of the present invention;

FIG. 5 is a diagrammatic representation of an assembly according to a fifth embodiment of the present invention;

FIG. 6 is a diagrammatic representation of an extendable structure of one embodiment of the present invention comprising a plurality of interconnected assemblies according to the embodiment of FIG. 3;

FIG. 7a is a diagrammatic representation of an extendable structure of a further embodiment of the present invention comprising a plurality of interconnected assemblies according generally to the embodiment of FIG. 4, for which the value of ϕ is 1.285;

FIG. 7b is a diagram of the members required to construct the structure of FIG. 7a;

FIG. 7c is a diagrammatic representation of an extendable structure of a further embodiment of the present invention comprising an assembly generally according to the embodiment of FIG. 4, for which the value of ϕ is 1.285;

FIG. 7d is a diagrammatic representation of an extendable structure of a further embodiment of the present invention comprising a plurality of interconnected assemblies according generally to the embodiment of FIG. 3, for which the value of ϕ is 1.285;

FIG. 7e is a diagrammatic representation of an extendable structure of a further embodiment of the present invention comprising an assembly generally according to the embodiment of FIG. 4, for which the value of ϕ is 1.285;

FIG. 7f is a diagrammatic representation of an extendable structure of a further embodiment of the present invention comprising a plurality of interconnected assemblies according generally to the embodiment of FIG. 3, for which the value of ϕ is 1.285;

FIG. 8a is a diagrammatic representation of an extendable structure of a further embodiment of the present invention comprising a plurality of interconnected assemblies according generally to the embodiment of FIG. 4, for which the value of ϕ is 1.414;

FIG. 8b is a diagram of the members required to construct the structure of FIG. 8a;

FIG. 8c is a diagrammatic representation of an extendable structure of a further embodiment of the present invention comprising an assembly generally according to the embodiment of FIG. 4, for which the value of ϕ is 1.414;

FIG. 8d is a diagrammatic representation of an extendable structure of a further embodiment of the present invention comprising a plurality of interconnected assemblies according generally to the embodiment of FIG. 3, for which the value of ϕ is 1.414;

FIG. 8e is a diagrammatic representation of an extendable structure of a further embodiment of the present invention comprising an assembly generally according to the embodiment of FIG. 4, for which the value of ϕ is 1.414;

FIG. 8f is a diagrammatic representation of an extendable structure of a further embodiment of the present invention comprising a plurality of interconnected assemblies according generally to the embodiment of FIG. 3, for which the value of ϕ is 1.414;

FIG. 9a is a diagrammatic representation of an extendable structure of a further embodiment of the present invention comprising a plurality of interconnected assemblies according generally to the embodiment of FIG. 4, for which the value of ϕ is 1.532;

FIG. 9b is a diagram of the members required to construct the structure of FIG. 9a;

FIG. 9c is a diagrammatic representation of an extendable structure of a further embodiment of the present invention comprising an assembly generally according to the embodiment of FIG. 4, for which the value of ϕ is 1.532;

FIG. 9d is a diagrammatic representation of an extendable structure of a further embodiment of the present invention comprising a plurality of interconnected assemblies according generally to the embodiment of FIG. 3, for which the value of ϕ is 1.532;

FIG. 9e is a diagrammatic representation of an extendable structure of a further embodiment of the present invention comprising an assembly generally according to the embodiment of FIG. 4, for which the value of ϕ is 1.532;

FIG. 9f is a diagrammatic representation of an extendable structure of a further embodiment of the present invention comprising a plurality of interconnected assemblies according generally to the embodiment of FIG. 3, for which the value of ϕ is 1.532;

FIG. 10a is a diagrammatic representation of an extendable structure of a further embodiment of the present invention comprising a plurality of interconnected assemblies according generally to the embodiment of FIG. 4, for which the value of ϕ is 1.618;

FIG. 10b is a diagram of the members required to construct the structure of FIG. 10a;

FIG. 10c is a diagrammatic representation of an extendable structure of a further embodiment of the present invention comprising an assembly generally according to the embodiment of FIG. 4, for which the value of ϕ is 1.618;

FIG. 10d is a diagrammatic representation of an extendable structure of a further embodiment of the present invention comprising a plurality of interconnected assemblies according generally to the embodiment of FIG. 3, for which the value of ϕ is 1.618;

FIG. 10e is a diagrammatic representation of an extendable structure of a further embodiment of the present invention comprising an assembly generally according to the embodiment of FIG. 4, for which the value of ϕ is 1.618;

FIG. 10f is a diagrammatic representation of an extendable structure of a further embodiment of the present invention comprising a plurality of interconnected assemblies according generally to the embodiment of FIG. 3, for which the value of ϕ is 1.618;

FIG. 11a is a diagrammatic representation of an extendable structure of a further embodiment of the present invention comprising a plurality of interconnected assemblies according generally to the embodiment of FIG. 4, for which the value of ϕ is 1.732;

FIG. 11b is a diagram of the members required to construct the structure of FIG. 11a;

FIG. 11c is a diagrammatic representation of an extendable structure of a further embodiment of the present invention comprising an assembly generally according to the embodiment of FIG. 4, for which the value of ϕ is 1.732;

FIG. 11d is a diagrammatic representation of an extendable structure of a further embodiment of the present invention comprising a plurality of interconnected assemblies according generally to the embodiment of FIG. 3, for which the value of ϕ is 1.732;

FIG. 11e is a diagrammatic representation of an extendable structure of a further embodiment of the present invention comprising an assembly generally according to the embodiment of FIG. 4, for which the value of ϕ is 1.732; and

FIG. 11f is a diagrammatic representation of an extendable structure of a further embodiment of the present invention comprising a plurality of interconnected assemblies according generally to the embodiment of FIG. 3, for which the value of ϕ is 1.732.

In the embodiments shown in the accompanying figures, the assemblies are formed from a plurality of members. Each of the members is represented as an elongate bar or arm. However, it is to be understood that the members may take other forms, as generally described above.

### DETAILED DESCRIPTION OF THE INVENTION

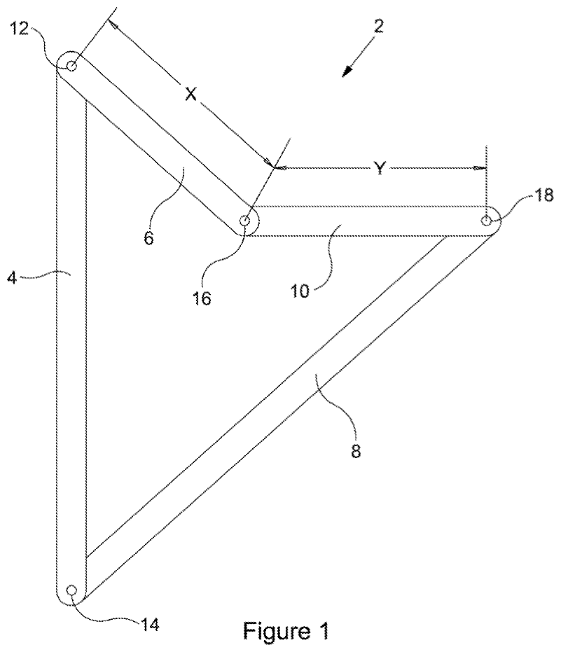

Turning first to FIG. 1, there is shown a diagrammatic representation of an assembly according to one embodiment of the present invention. The assembly, generally indicated as 2, comprises a first member 4, a second member 6, a third member 8 and a fourth member 10. The assembly 2 is shown in FIG. 1 in an extended position.

In the assembly 2 of FIG. 1, the second member 6 is pivotally connected to the first member 4 at a position 12 forming a first position on the first member and a first position on the second member. The third member 8 is pivotally connected to the first member 4 at a position 14 forming a second position on the first member and a first position on the third member. The fourth member 10 is pivotally connected to the second member 6 at a position 16 forming a second position on the second member and a first position on the fourth member. The fourth member 10 is further pivotally connected to the third member 8 at a position 18 forming a second position on the third arm 8 and a second position on the fourth arm 10.

In the assembly of FIG. 1, the distance between the positions 12 and 16 along the second member 6 is the distance X. Similarly, the distance between the positions 16 and 18 along the fourth member 10 is the distance Y. In the assembly of FIG. 1, the distances X and Y are equal.

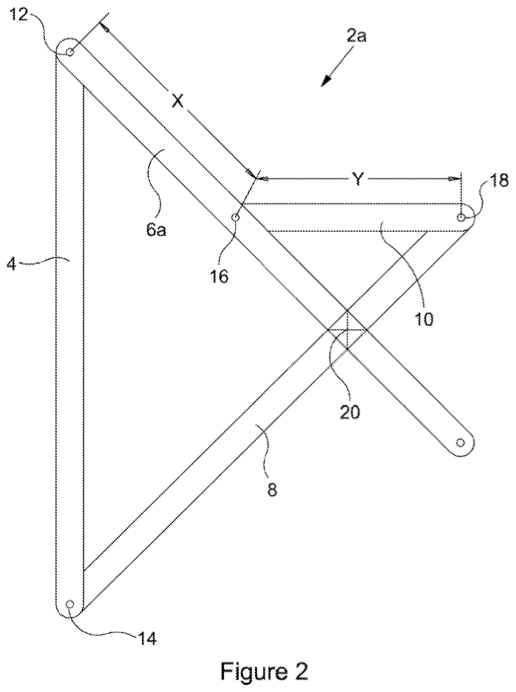

Turning to FIG. 2, there is shown an assembly according to a second embodiment of the present invention. The assembly, generally indicated as 2a, comprises first, second, third and fourth members arranged as shown in FIG. 1 and described above. The components and features common to FIGS. 1 and 2 are indicated using the same reference numerals and are as described above. Differences between the assemblies of FIGS. 1 and 2 are as follows:

In the assembly 2a of FIG. 2, the second member 6a extends in the direction from the position 12 to the position 16 beyond the position 16 and beyond the third arm 8. Optionally, a locking mechanism 20 is provided to lock the second member 6 and the third member 8 in the extended position.

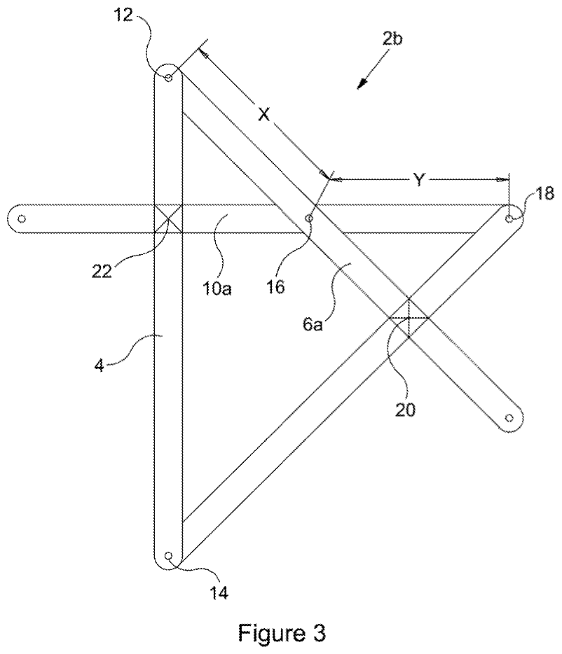

Turning to FIG. 3, there is shown an assembly according to a third embodiment of the present invention. The assembly, generally indicated as 2b, comprises first, second, third and fourth members arranged as shown in FIGS. 1 and 2 and described above. The components and features common to FIGS. 1, 2 and 3 are indicated using the same reference numerals and are as described above. Differences between the assemblies of FIGS. 1, 2 and 3 are as follows:

In the assembly 2b of FIG. 3, the fourth member 10a extends in the direction from the position 18 to the position 16 beyond the position 16 and beyond the first arm 4. Optionally, a locking mechanism 22 is provided to lock the fourth member 10 and the first member 4 in the extended position.

In the assembly 2b of FIG. 3, the assembly is formed from four members 4, 8, 6a and 10a of equal length.

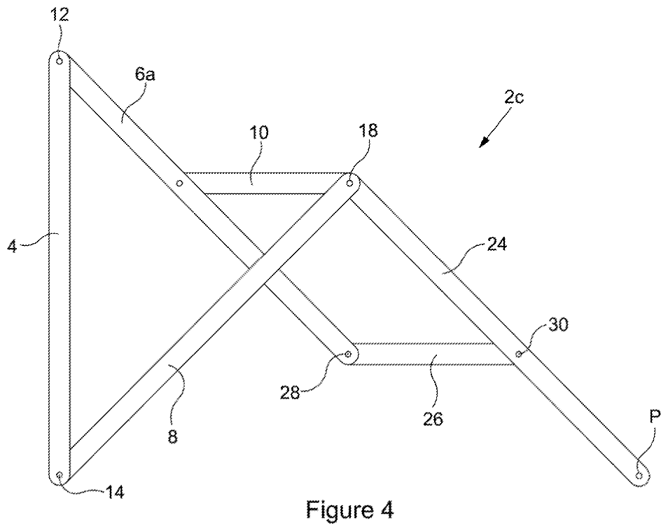

Turning to FIG. 4, there is shown an assembly according to a fourth embodiment of the present invention. The assembly, generally indicated as 2c, comprises first, second, third and fourth members arranged as shown in FIGS. 1 and 2 and described above. The components and features common to FIGS. 1, 2 and 4 are indicated using the same reference numerals and are as described above. Differences between the assemblies of FIGS. 1, 2 and 4 are as follows:

The assembly 2c further comprises a fifth member 24. The fifth member is pivotally connected to the position 18 forming a first position on the fifth member, such that the fifth member 24 is pivotally connected to both the third member and the fourth member at the position 18.

The assembly 2c further comprises a sixth member 26. The sixth member 26 is pivotally connected to the second member at a position 28 forming a third position on the second member and a first position on the sixth member. The sixth member 26 is further pivotally connected to the fifth member 24 at a position 30 forming a second position on the fifth member 24 and a second position on the sixth member 26.

The fifth member 24 has a position P thereon. In operation, when the assembly 2c is moved between a retracted position, in which the members of the assembly lie adjacent each other, and the extended position shown in FIG. 4, the point P moves in a substantially straight line extending perpendicular to the first member 4.

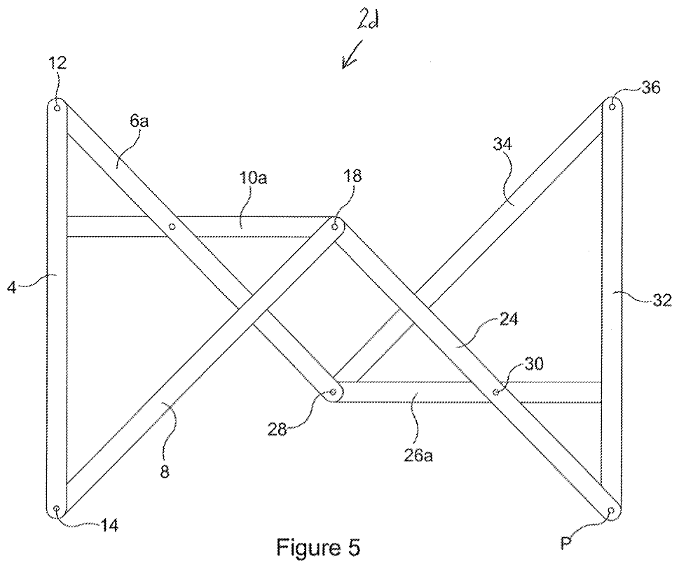

Turning to FIG. 5, there is shown an assembly according to a further embodiment of the present invention. The assembly, generally indicated as 2d, comprises the components of the assembly of FIG. 4, which are indicated in FIG. 5 using the same reference numerals and are as described above.

The assembly 2d of FIG. 5 further comprises a seventh member 32, pivotally connected at a first position on the seventh member to the point P on the fifth member 24. An eighth member 34 is pivotally connected at a first position on the eighth member to the position 28, thereby pivotally connected to the second member 6a and the sixth member 26a. The eighth member 34 is further pivotally connected to the seventh member 32 at a position 36, forming a second position on the eighth member 34 and a second position on the seventh member 32.

The sixth member 26a extends beyond the fifth member 24 towards the seventh member 32 and can be provided with a locking mechanism to lock the sixth and eighth members together in the extended position shown.

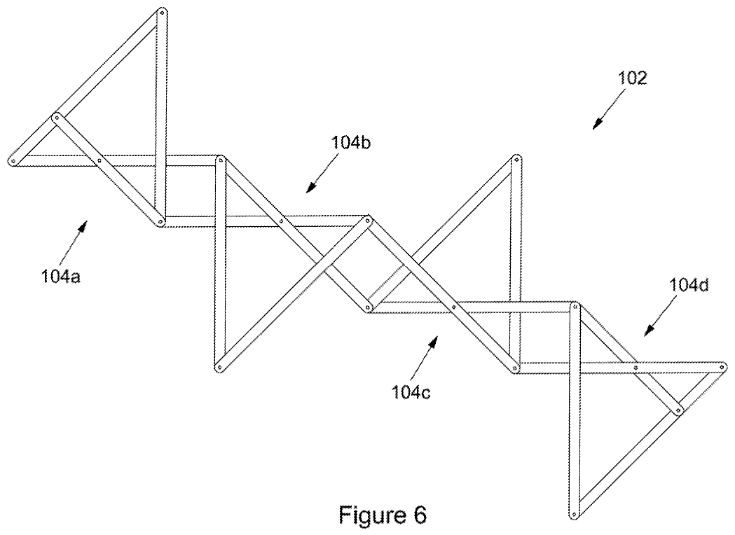

Referring now to FIG. 6, there is shown a structure, generally indicated as 102. The structure 102 is an expandable structure and is shown in an extended position in FIG. 6. The structure comprises a plurality of the assemblies shown in FIG. 3 and described above. In particular, the structure 102 comprises four interconnected assemblies 104a, 104b, 104c, 104d. Adjacent assemblies in the structure 102 are interconnected by way of a pivotal connection between each assembly 104a, 104b, 104c, 104d and the second and fourth members 6a, 10a of each adjacent assembly.

The structure 102 of FIG. 6 is an example of the use of the assemblies of the present invention as modules in forming larger expandable structures. As will appreciated, FIG. 6a shows one example employing four assemblies in a modular manner. However, similar structures can be formed employing fewer than four assemblies or more than four assemblies, as required for a particular application.

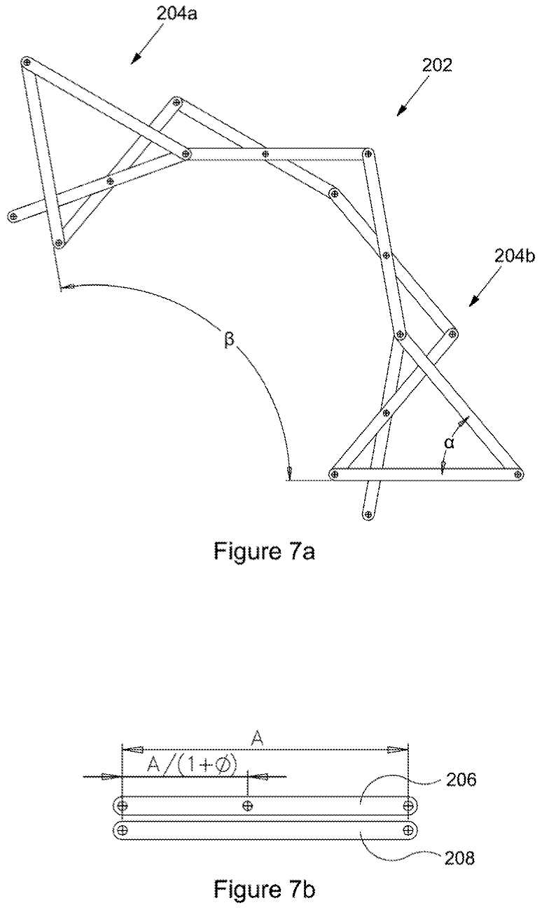

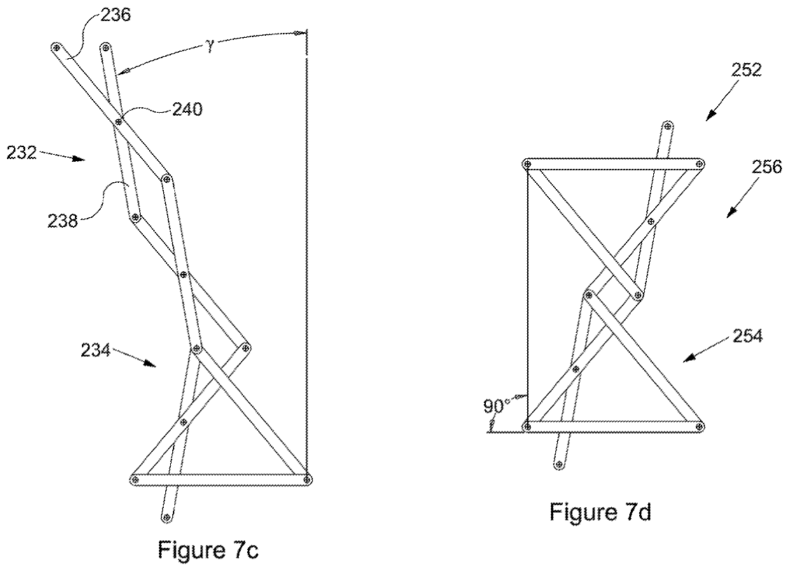

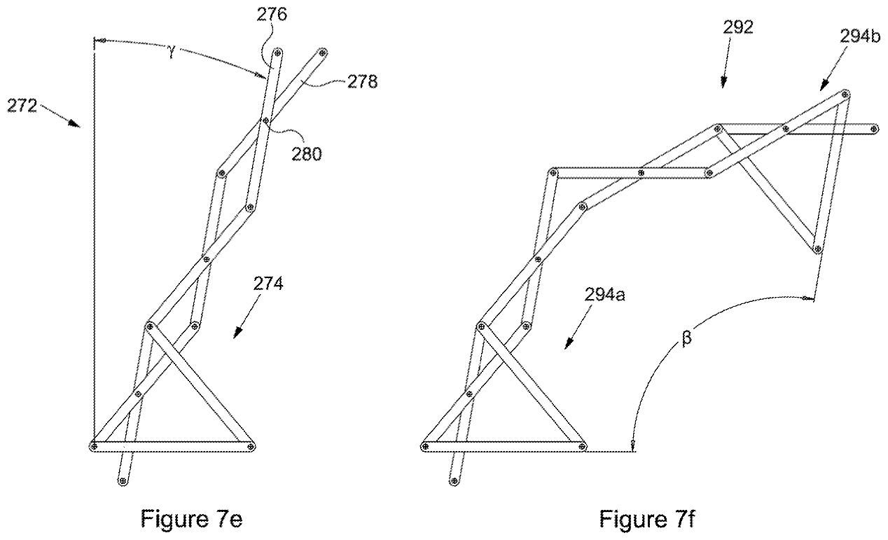

Turning to FIG. 7a, there is shown a diagrammatic representation of a structure comprising a plurality of interconnected assemblies. The structure of FIG. 7a is formed from a plurality of assemblies in which 1=1.285.

The structure, generally indicated as 202, comprises two assemblies 204a, 204b of the general configuration shown in FIG. 4 and described above. The assemblies 204a, 204b are interconnected first by having the point P on the fifth member of the assembly 204a pivotally connected to the point P on the fifth member of the assembly 204b. Further, the sixth member of each assembly 204a, 204b is extended beyond the fifth member, with the ends of the sixth members pivotally connected to each other.

The members required to form the structure of FIG. 7a are shown in FIG. 7b. The members of the structure 202 are all equal in length, with the difference in the members being the number of pivot connections provided. More particularly, the structure 202 is formed from eight members 206 and four members 208. The members 206 are characterised by having means for forming a pivot connection provided at three positions on the member, in particular a first position at one end, a second position at a second end and a third position a distance A/(1+ϕ) from the first position, where A is the distance between the first and second positions, as indicated in FIG. 7b. The members 208 are characterised by having means for forming a pivot connection provided at two positions on the member, in particular a first position at one end and a second position at a second end.

The assembly 202 of FIG. 7a is formed from eight members 206 and four members 208 shown in FIG. 7b. The members forming the structure 202 are all equal in length.

As shown in FIG. 7a, the structure is in an extended position, with the structure extended through an angle of β, where β=2.arccos(ϕ/2), that is an angle of 100°. The angle α between the first and third members of the assembly 204b is provided by the relationship α=arccos(ϕ/2), that is an angle of 50°.

Referring to FIG. 7c, a structure according to a further embodiment of the present invention is shown. The structure, generally indicated as 232, comprises an assembly 234 of the general configuration shown in FIG. 4 and described above, for which ϕ=1.285.

In the assembly 234, the sixth member is extended beyond the fifth member. The structure 232 further comprises a first additional member 236, pivotally connected at one end to the point P on the fifth member of the assembly 234, and a second additional member 238 pivotally connected at a first end to the end of the sixth member, with the first and second additional members 236, 238 pivotally connected to each other at a position 240 between the ends of each member.

The members required to form the structure 232 of FIG. 7c are as shown in FIG. 7b and described above. The structure 232 of FIG. 7c requires six members 206 and two members 208. Again, all the members of the structure 232 are of the same length.

It is to be noted that the first and second additional members 236, 238 are arranged in the structure 232 in a first orientation, with the first additional member 236 arranged in the opposite manner about the position 240 to the second additional member 238.

As indicated in FIG. 7c, with the structure 232 in the extended position shown, a straight line is defined by the ends of members of the structure. The straight line extends at an angle γ=arccos(ϕ/2)/2, that is 25°, to the line extending perpendicular to the first member of the assembly 234.

Referring to FIG. 7d, a structure according to a further embodiment of the present invention is shown. The structure, generally indicated as 252, comprises a first assembly 254 and a second assembly 256, both of the general configuration shown in FIG. 3 and described above, and for both of which ϕ=1.285.

In the structure 252, the first assembly 254 and the second assembly 256 are interconnected, with the first assembly inverted relative to the second assembly and the end of the third member of each assembly pivotally connected to the end of the fourth member of the other assembly.

The members required to form the structure 252 of FIG. 7d are as shown in FIG. 7b and described above. The structure 252 of FIG. 7d requires four members 206 and fourth members 208. Again, all the members of the structure 232 are of the same length.

The assembly is shown in FIG. 7d in an extended position, in which the ends of the members define a straight line extending at 90° to the line joining the first and second fixed pivots, as indicated in FIG. 7d.

Referring to FIG. 7e, a structure according to a further embodiment of the present invention is shown. The structure, generally indicated as 272, comprises an assembly 274 of the general configuration shown in FIG. 4 and described above, for which ϕ=1.285.

In the assembly 274, the sixth member is extended beyond the fifth member. The structure 272 further comprises a first additional member 276, pivotally connected at one end to the point P on the fifth member of the assembly 274, and a second additional member 278 pivotally connected at a first end to the end of the sixth member, with the first and second additional members 276, 278 pivotally connected to each other at a position 280 between the ends of each member.

The members required to form the structure 272 of FIG. 7e are as shown in FIG. 7b and described above. The structure 272 of FIG. 7e requires six members 206 and two members 208. Again, all the members of the structure 272 are of the same length.

It is to be noted that the first and second additional members 276, 278 are arranged in the structure 272 in a second orientation, opposite to the orientation in the structure 232 of FIG. 7c, again with the first additional member 276 arranged in the opposite manner about the position 280 to the second additional member 278. This results in the structure assuming an opposite configuration when in the extended position, as shown by a comparison of FIGS. 7c and 7e.

As indicated in FIG. 7e, with the structure 272 in the extended position shown, a straight line is defined by the ends of members of the structure. The straight line extends at an angle γ=arccos(ϕ/2)/2, that is 25°, to the line extending perpendicular to the first member of the assembly 274.

Turning to FIG. 7f, there is shown a diagrammatic representation of a structure comprising a plurality of interconnected assemblies. The structure of FIG. 7f is formed from a plurality of assemblies in which ϕ=1.285.

The structure, generally indicated as 292, comprises two assemblies 294a, 294b of the general configuration shown in FIG. 4 and described above. The assemblies 294a, 294b are interconnected first by having the point P on the fifth member of the assembly 294a pivotally connected to the point P on the fifth member of the assembly 294b. Further, the sixth member of each assembly 294a, 294b is extended beyond the fifth member, with the ends of the sixth members pivotally connected to each other.

The members required to form the structure of FIG. 7e are shown in FIG. 7b. The assembly 292 of FIG. 7f is formed from eight members 206 and four members 208 shown in FIG. 7b. The members forming the structure 292 are all equal in length.

It is to be noted that the orientation of the sixth members in both the assemblies 294a, 294b is reversed to that in the structure 202 of FIG. 7a. This results in the structure assuming an opposite configuration when in the extended position, as shown by a comparison of FIGS. 7a and 7f.

As shown in FIG. 7f, the structure is in an extended position, with the structure extended through an angle of β, where β=2.arccos(ϕ/2), that is an angle of 100°.

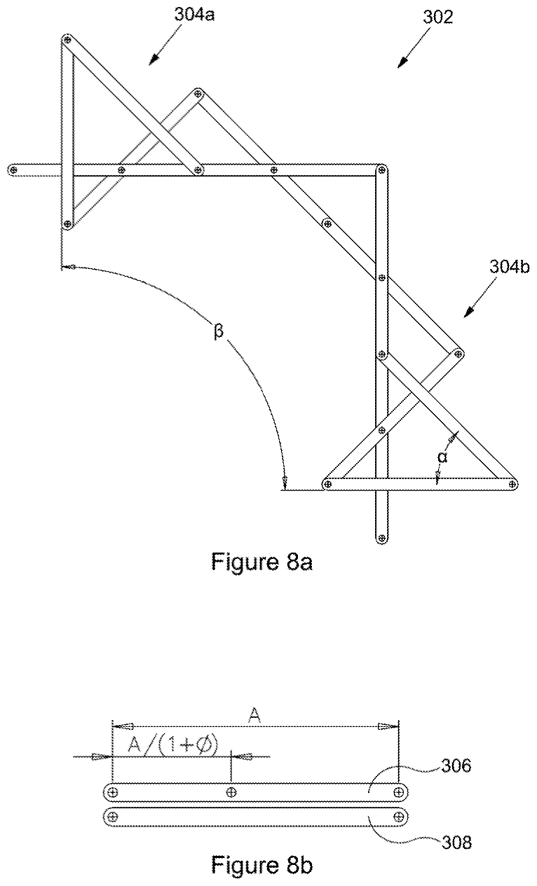

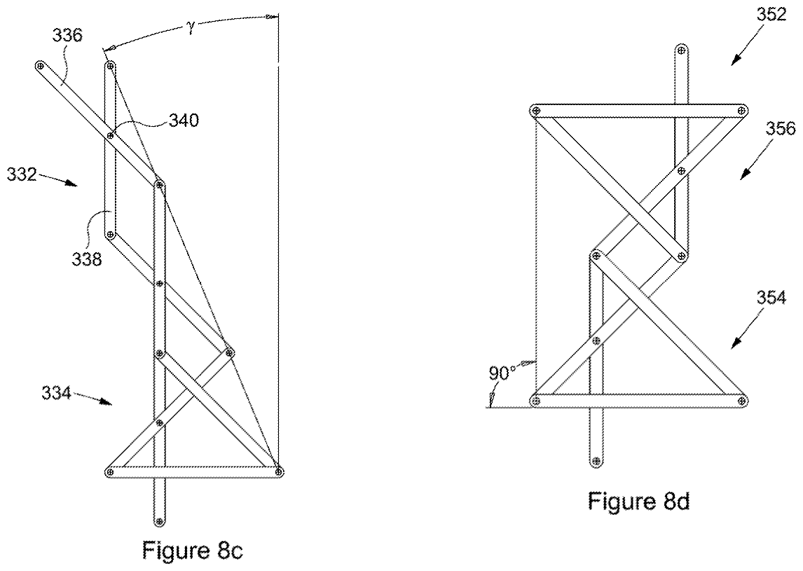

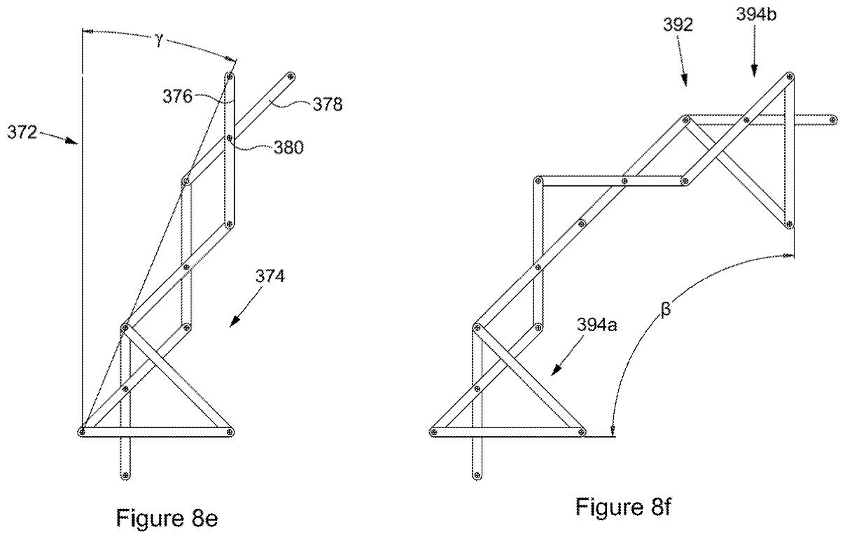

The structures shown in FIGS. 7a to 7f are examples of structures obtainable using the basic assembly of FIG. 3 with a value of ϕ=1.285. The principles underlying the structures of FIGS. 7a to 7f and their behaviour and configuration can be applied using different values of ϕ. Examples of alternative structures obtained when the value of ϕ is varied with the range 1<ϕ≤2 are shown in FIGS. 8 to 11 and discussed below.

Turning to FIG. 8a, there is shown a diagrammatic representation of a structure comprising a plurality of interconnected assemblies. The structure of FIG. 8a is formed from a plurality of assemblies in which ϕ is equal to the square root of 2, that is ϕ=1.414.

The structure, generally indicated as 302, comprises two assemblies 304a, 304b of the general configuration shown in FIG. 4 and described above. The assemblies 304a, 304b are interconnected in an analogous manner to that of the assembly of FIG. 7a, that is first by having the point P on the fifth member of the assembly 304a pivotally connected to the point P on the fifth member of the assembly 304b. Further, the sixth member of each assembly 304a, 304b is extended beyond the fifth member, with the ends of the sixth members pivotally connected to each other.

The members required to form the structure of FIG. 8a are shown in FIG. 8b. The members of the structure 302 are all equal in length, with the difference in the members being the number of pivot connections provided. More particularly, the structure 302 is formed from eight members 306 and four members 308. The members 306 are characterised by having means for forming a pivot connection provided at three positions on the member, in particular a first position at one end, a second position at a second end and a third position a distance A/(1+ϕ) from the first position, where A is the distance between the first and second positions, as indicated in FIG. 8b. The members 308 are characterised by having means for forming a pivot connection provided at two positions on the member, in particular a first position at one end and a second position at a second end.

As shown in FIG. 8a, the structure is in an extended position, with the structure extended through an angle of β, where β=2.arccos(ϕ/2), that is an angle of 90°. The angle α between the first and third members of the assembly 304b is provided by the relationship α=arccos(ϕ/2), that is an angle of 45°.

FIGS. 8c to 8f show assemblies directly analogous to the assemblies of FIGS. 7c to 7f and described above, but in which ϕ=1.414.

As indicated in FIG. 8c, with the structure 332 in the extended position shown, a straight line is defined by the ends of members of the structure. The straight line extends at an angle γ=arccos(ϕ/2)/2, that is 22.5°, to the line extending perpendicular to the first member of the assembly 334.

The assembly is shown in FIG. 8d in an extended position, in which the ends of the members define a straight line extending at 90° to the line joining the first and second fixed pivots, as indicated in FIG. 8d. It is to be noted that the fourth member of each assembly 354 and 356 extends perpendicular to the line joining the first and second fixed pivots. This is an advantage of forming the assemblies with ϕ=1.414.

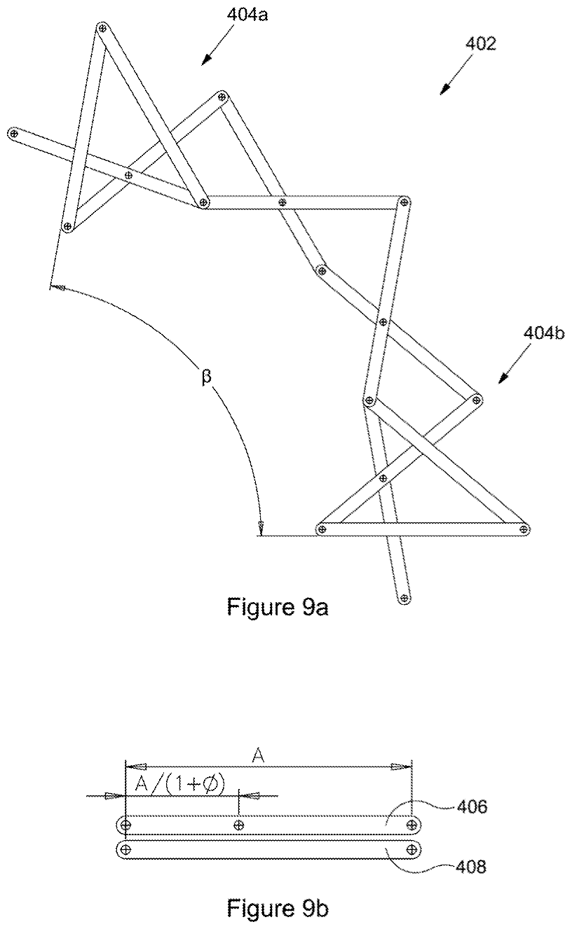

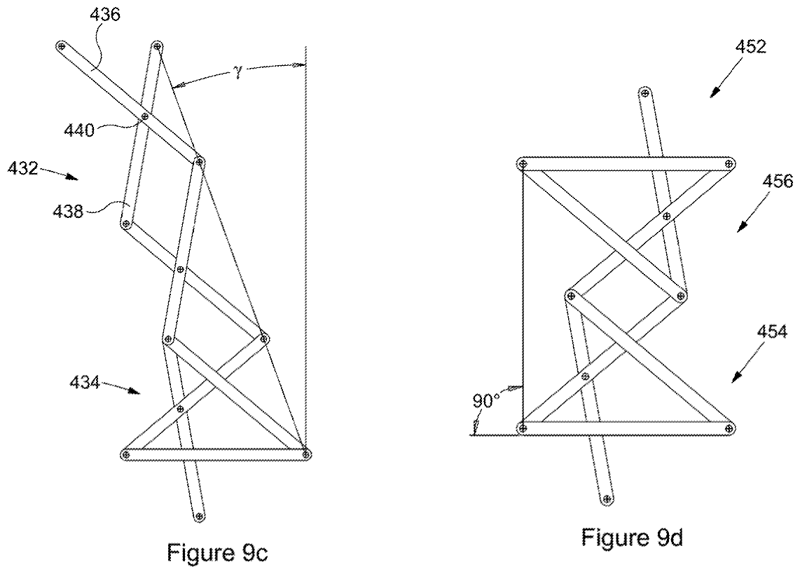

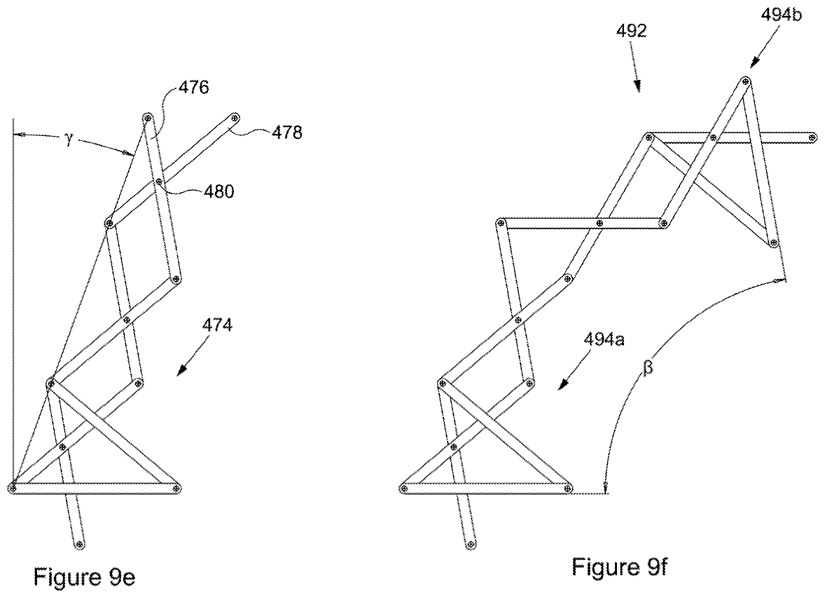

Turning to FIG. 9a, there is shown a diagrammatic representation of a structure comprising a plurality of interconnected assemblies. The structure of FIG. 9a is formed from a plurality of assemblies in which ϕ=1.532.

The structure, generally indicated as 402, comprises two assemblies 404a, 404b of the general configuration shown in FIG. 4 and described above. The assemblies 404a, 404b are interconnected in an analogous manner to that of the assembly of FIG. 7a, that is first by having the point P on the fifth member of the assembly 404a pivotally connected to the point P on the fifth member of the assembly 404b. Further, the sixth member of each assembly 404a, 404b is extended beyond the fifth member, with the ends of the sixth members pivotally connected to each other.

The members required to form the structure of FIG. 9a are shown in FIG. 9b. The members of the structure 402 are all equal in length, with the difference in the members being the number of pivot connections provided. More particularly, the structure 402 is formed from eight members 406 and four members 408. The members 406 are characterised by having means for forming a pivot connection provided at three positions on the member, in particular a first position at one end, a second position at a second end and a third position a distance A/(1+ϕ) from the first position, where A is the distance between the first and second positions, as indicated in FIG. 9b. The members 408 are characterised by having means for forming a pivot connection provided at two positions on the member, in particular a first position at one end and a second position at a second end.

As shown in FIG. 9a, the structure is in an extended position, with the structure extended through an angle of β, where β=2.arccos(ϕ/2), that is an angle of 80°. The angle α between the first and third members of the assembly 404b is provided by the relationship α=arccos(ϕ/2), that is an angle of 40°.

FIGS. 9c to 9f show assemblies directly analogous to the assemblies of FIGS. 7c to 7f and described above, but in which 1=1.532.

As indicated in FIG. 9c, with the structure 432 in the extended position shown, a straight line is defined by the ends of members of the structure. The straight line extends at an angle γ=arccos(ϕ/2)/2, that is 20°, to the line extending perpendicular to the first member of the assembly 434.

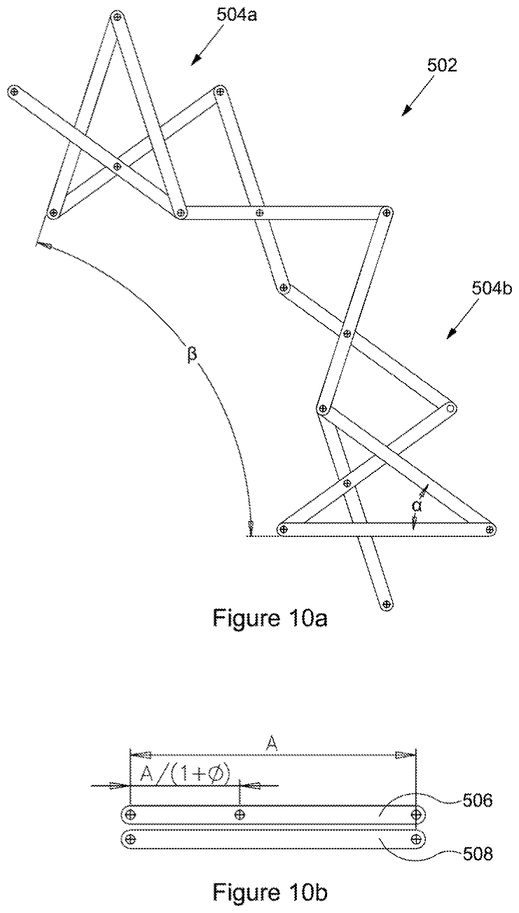

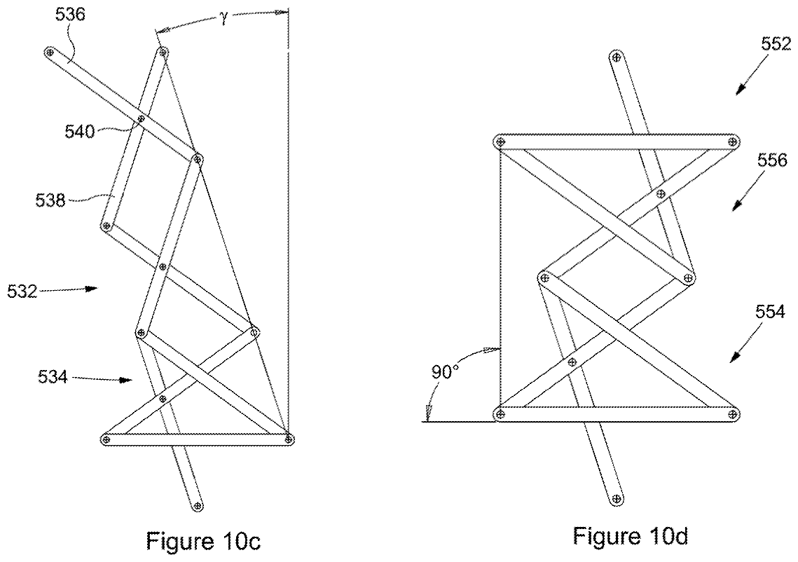

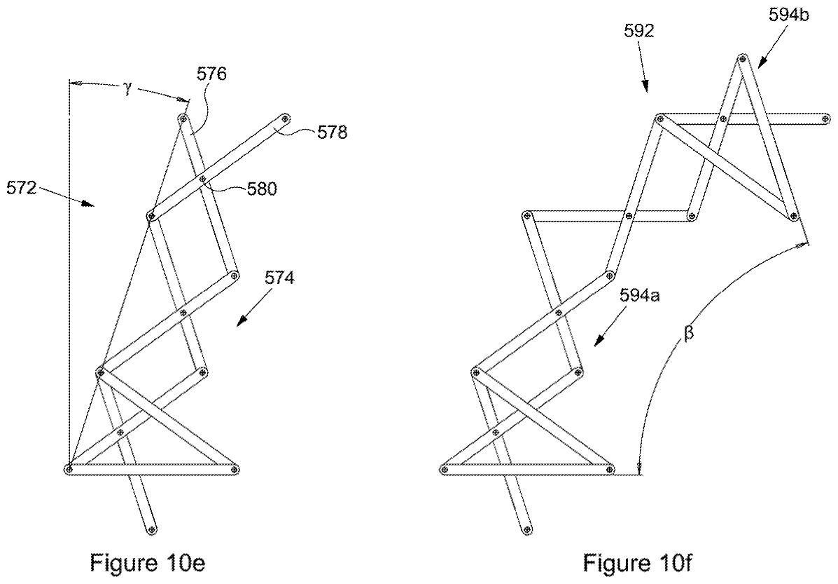

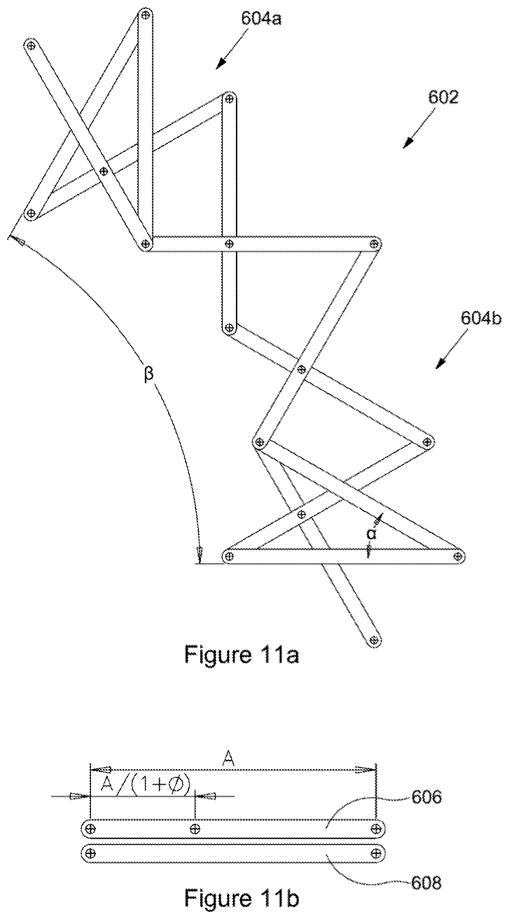

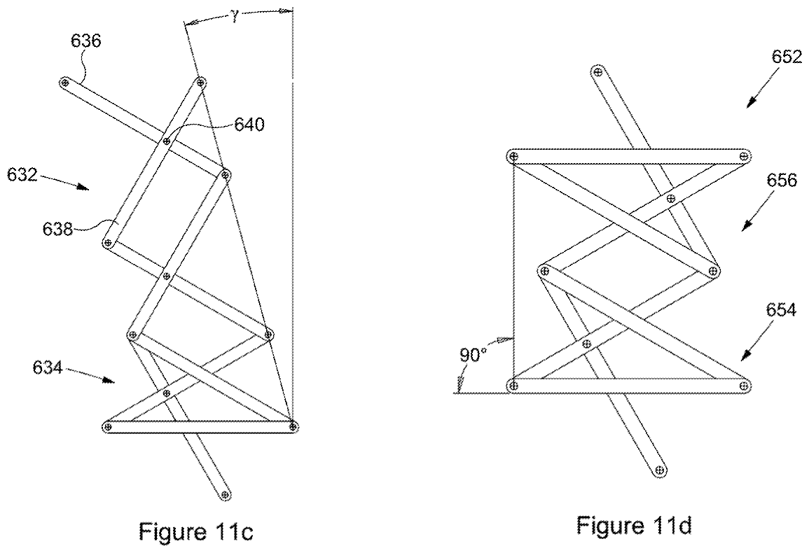

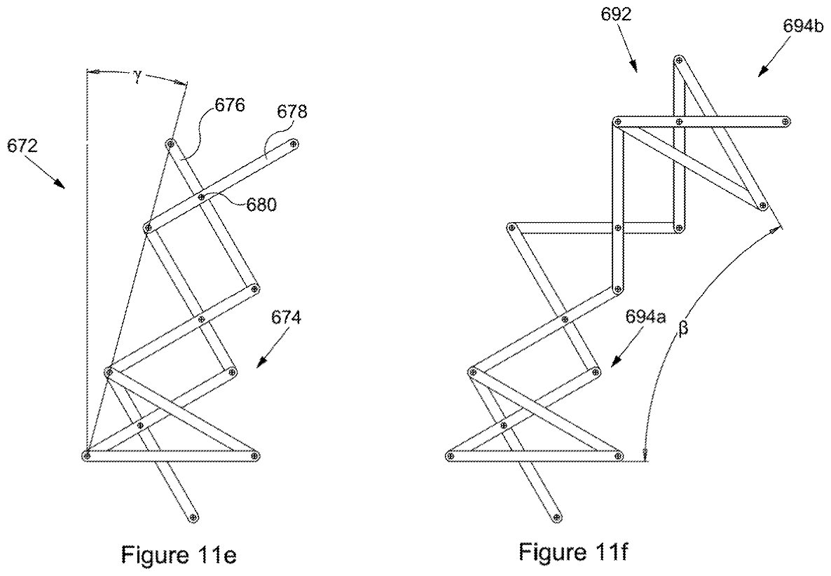

FIGS. 10a to 10f and 11a to 11f show assemblies formed in an analogous manner to those of FIGS. 7a to 7f, 8a to 8f and 9a to 9f as described above, but with different values of ϕ. These figures are included to show the variation in the arrangement and function of the assemblies available from varying the value of ϕ. In the case of the assemblies of FIGS. 10a to 10f, ϕ is equal to one plus the square root of 5, all divided by 2, that is ϕ=1.618. In the case of the assemblies of FIGS. 11a to 11f, ϕ is equal to the square root of 3, that is ϕ=1.732.

1. An assembly for converting motion, the assembly comprising:
a first member;
a second member pivotally connected at a first position on the second member to a first position on the first member;
a third member pivotally connected at a first position on the third member to a second position on the first member, the second position on the first member being spaced apart from the first position on the first member; and
a fourth member pivotally connected at a first position on the fourth member to a second position on the second member and pivotally connected at a second position on the fourth member to a second position on the third member, the second position on the second member being spaced apart from the first position on the second member and the second position on the third member being spaced apart from the first position on the third member;
wherein the distance between the first position on the second member and the second position on the second member is a distance X and the distance between the first position on the fourth member and the second position on the fourth member is a distance Y;
wherein the distance X is equal to the distance Y; and
wherein the second member extends from the first position on the second member in the direction of the second position of the second member beyond the second position on the second member.

2. The assembly according to claim 1, wherein in an extended position the second member extends from the second position on the second member in the direction of the first position on the second member beyond the first position on the second member to or beyond the first member.

3. The assembly according to claim 1, wherein the first, second, third and fourth members have the same length.

4. The assembly according to claim 1, further comprising:
a fifth member pivotally connected at a first position on the fifth member to the second position on the third member and the second position on the fourth member; and
a sixth member pivotally connected at a first position on the sixth member to a third position on the second member, wherein the third position on the second member is spaced from the second position on the second member in the direction extending from the first position on the second member to the second position on the second member, and a second position on the fifth member, the second position on the fifth member being spaced apart from the first position on the fifth member.

5. The assembly according to claim 4, wherein the fifth member is of a sufficient length that a point P on the fifth member spaced from the first and second positions on the fifth member and beyond the second position in the direction from the first to the second position on the fifth member moves in a substantially straight line as the assembly moves between the retracted position and an extended position;
the assembly further comprising:
a seventh member pivotally connected at a first position on the seventh member to the point P on the fifth member; and
an eighth member pivotally connected at a first position on the eighth member to the third position on the second member and pivotally connected at a second position on the eighth member to a second position on the seventh member, the second position on the seventh member being spaced apart from the first position on the seventh member.

6. The assembly according to claim 1, wherein the distance between the first and second position on the first member is A and wherein X and Y have a length represented by the following formula (I):
A/(1+ϕ) (I)
where ϕ is as follows:
1ϕ≤2.

7. The assembly according to claim 6, wherein ϕ is from 1.1 to ≤2.

8. The assembly according to claim 6, wherein an angle α is formed between the first member and the third member when the assembly is in an extended position, the angle α defined by formula (II):
α=arccos(ϕ/2) (II)
and
ϕ has a value to give an angle α of from 5° up to 59°.

9. The assembly according to claim 6, wherein ϕ has the value of 1.285, SQRT(2), 1.532, [(SQRT(5)+1)/2], or SQRT(3).

10. A method for providing an assembly for converting motion, the method comprising:
providing a first member;
providing a second member pivotally connected at a first position on the second member to a first position on the first member;
providing a third member pivotally connected at a first position on the third member to a second position on the first member, the second position on the first member being spaced apart from the first position on the first member; and
providing a fourth member pivotally connected at a first position on the fourth member to a second position on the second member and pivotally connected at a second position on the fourth member to a second position on the third member, the second position on the second member being spaced apart from the first position on the second member and the second position on the third member being spaced apart from the first position on the third member;
wherein the distance between the first position on the second member and the second position on the second member is a distance X and the distance between the first position on the fourth member and the second position on the fourth member is a distance Y;
wherein the distance X is equal to the distance Y; and
wherein the second member extends from the first position on the second member in the direction of the second position of the second member beyond the second position on the second member;
the method further comprising:
determining the extent of straight line motion required to be generated by the assembly and the deviation of this motion from a straight line; and
selecting the value of X and Y to provide the predetermined motion.

11. The method according to claim 10, wherein the distance between the first and second position on the first member is A and wherein X and Y have a length represented by the following formula (I):
A/(1+ϕ) (I)
wherein ϕ is as follows:
1<ϕ≤2.

12. The method according to claim 11, wherein ϕ is less than 2.

13. The method according to claim 12, wherein ϕ is from 1.1 to ≤2.

14. The method according to claim 11, wherein ϕ has a value up to 1.95.

15. The method according to claim 11, wherein an angle α is formed between the first member and the third member when the assembly is in an extended position, the angle α defined by formula (II):
α=arccos(ϕ/2) (II)
and
ϕ has a value to give an angle α of from 5° up to 59°.

16. The method according to claim 11, wherein ϕ has the value of 1.285, SQRT(2), 1.532, [(SQRT(5)+1)/2], or SQRT(3).

17. An assembly comprising an assembly according to claim 1, wherein the first member is provided by a fixed structure, operation of the assembly providing movement of the members of the assembly with respect to the fixed structure.

18. The assembly according to claim 17, comprising a plurality of assemblies according to claim 1.

19. The assembly according to claim 18, wherein one or more members of a first assembly are directly connected to a member of a second assembly.

20. The assembly according to claim 18, wherein one or more members of a first assembly are indirectly connected to a member of a second assembly by way of one or more additional members.
